(19) United States
(12) Patent Application Publication
(10) Pub. No.: US 2025/0353227 A1
(43) Pub. Date: Nov. 20, 2025

(54) INJECTION MOLDING DEVICE

(71) Applicant: Shannon M. Rhoads, McClure, OH (US)

(72) Inventor: Shannon M. Rhoads, McClure, OH (US)

(21) Appl. No.: 19/206,396

(22) Filed: May 13, 2025

Related U.S. Application Data
(60) Provisional application No. 63/647,804, filed on May 15, 2024.
(60) Provisional application No. 63/673,361, filed on Jul. 19, 2024.

(51) Int. Cl. B29C 45/17; B29C 45/20

(52) U.S. Cl. CPC B29C 45/1775; B29C 45/20

(57) ABSTRACT

The present invention utilizes a keeper that is positioned on the upper surface of the block utilized in the injection molding process. The keeper is removably secured to the block and the keeper has a projection that engages a notch positioned on the outer circumference of a bushing. The keeper and bushing are designed so that they can be positioned and removed from the block as a single assembly. Appropriate securing devices engage the keeper to secure the keeper and bushing to the block.

### RELATED APPLICATIONS

This application claims priority to U.S. Provisional Application No. 63/647,804 filed under 35 U.S.C. § 111(b) on May 15, 2024 and Provisional Application No. 63/673,361 filed under 35 U.S.C. § 111(b) on Jul. 19, 2024, the disclosure of which is incorporated herein by reference in its entirety.

### BACKGROUND OF THE INVENTION

The invention is directed to a device utilized in injection molding equipment. In injection molding machinery molten plastic material is supplied under pressure to a substantially rectangular block to control the flow of the plastic material. A bore extends through the block to provide a passageway for the molten plastic material. A nozzle is positioned at one end of the bore and the nozzle is operatively connected to the mold where the final injection molded part is formed. The nozzle is a critical part in controlling the flow of the molten plastic material to the mold. The nozzle is formed from a material that allows the molten plastic material to be precisely delivered to the mold. A bushing is positioned in the end of the bore that is opposite to the end of the bore where the nozzle is located. A rod passes through the bushing, through the bore and engages the nozzle. The rod assists in controlling the flow of the molten plastic material that is supplied to the nozzle. The rod is moveably positioned in the bore. The bushing assists in locating the rod as the rod is moved in the bore. The material of the bushing is softer than the material of the block and it is necessary to periodically replace the bushing. In the past the bushing has contained a semicircular groove on one side and a dowel pin is positioned in a hole that extends through the block. The dowel pin is designed to engage the semicircular groove in the bushing to retain the bushing in the desired position in the bore that extends through the block. The dowel pin is held in position in the hole by a friction fit between the hole and the dowel pin. It is frequently difficult to remove the dowel pin from the block to allow the bushing to be replaced. When a new bushing is positioned in the bore of the block it is also frequently difficult to align the dowel pin with the groove in the side of the bushing. These deficiencies in the system for mounting and securing the bushing in the bore can significantly disrupt the injection molding process and the number of parts that are produced. In addition, the utilization of dowel pins can result in damage to the bushing and blocks that are used in the injection molding process. Accordingly, there is a need in the injection molding industry for a better way of securing and positioning the bushing.

### SUMMARY OF THE INVENTION

The present invention utilizes a keeper that is positioned on the upper surface of the block utilized in the injection molding process. The keeper is removably secured to the block and the keeper has a projection that engages a notch positioned on the outer circumference of a bushing. The keeper and bushing are designed so that they can be positioned and removed from the block as a single assembly. Appropriate securing devices engage the keeper to secure the keeper and bushing to the block.

### DESCRIPTION OF THE DRAWINGS

FIG. 1 is a perspective view of the components of an injection molding machine.

FIG. 2 is a perspective view of the bushing retention device.

FIG. 3 is a side elevational view of the bushing.

FIG. 4 is a plan view of the keeper device.

FIG. 5 is a perspective view of the keeper of FIG. 3.

FIG. 6 is a perspective view of a component of the invention.

FIG. 7 is a perspective view of the invention.

FIG. 8 is a perspective view of a feature of the invention.

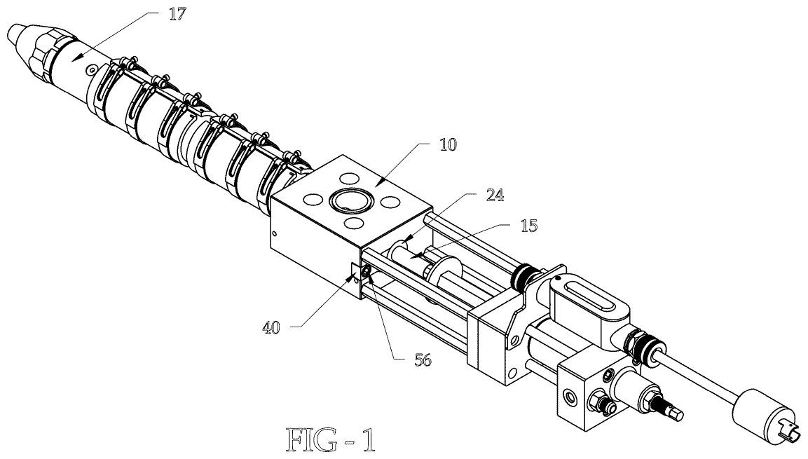

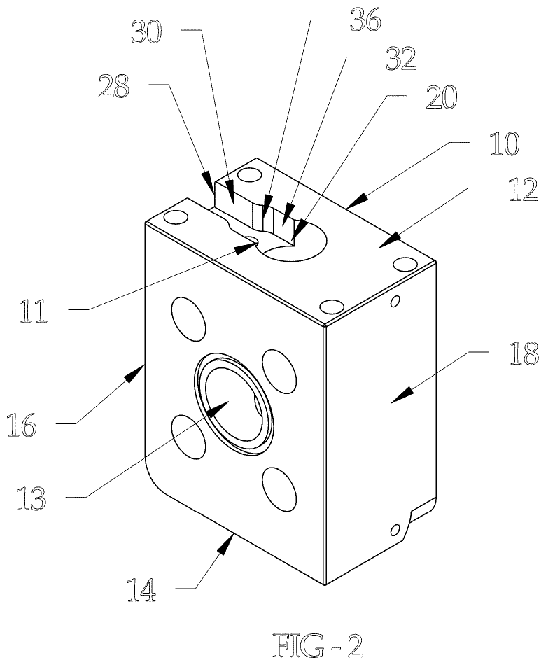

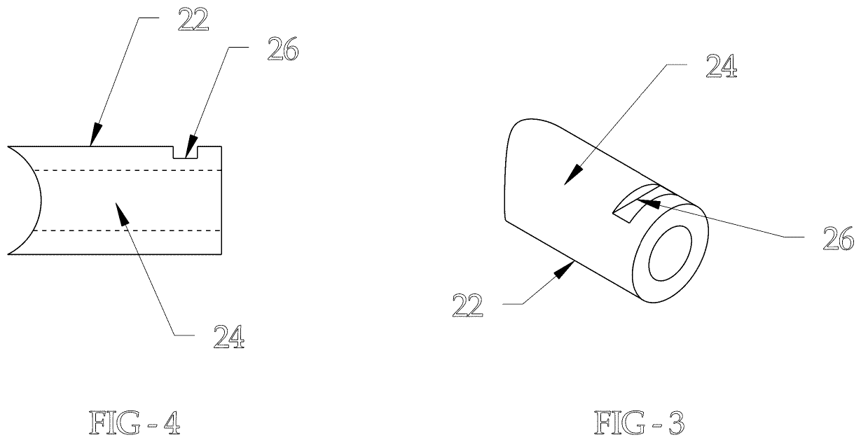

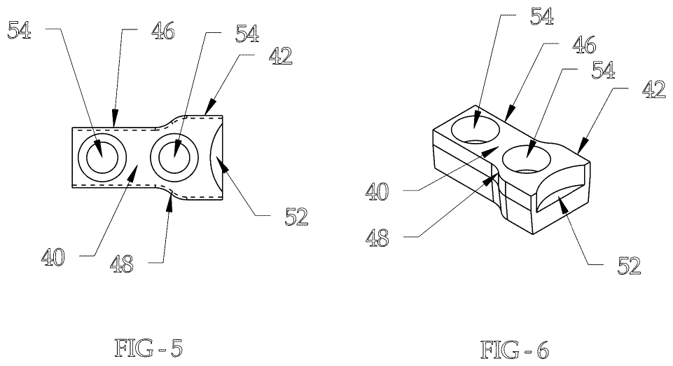

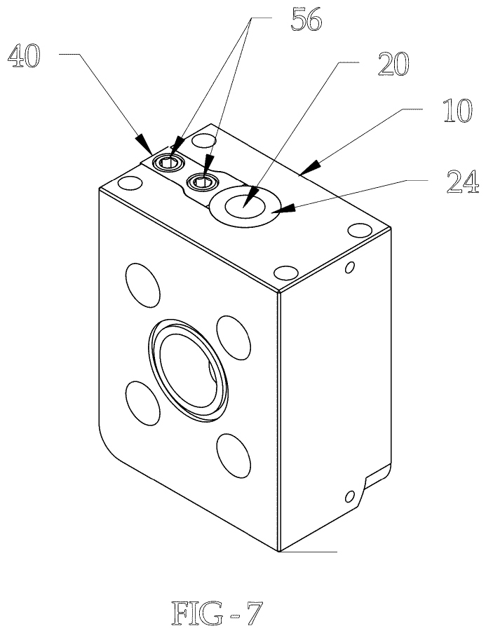

### DESCRIPTION OF THE INVENTION

This application is directed to an improvement or injection molding machine. More specifically the invention relates to a way to secure the bushing in the block that is utilized to supply molten plastic to a mold. The features of the invention will be more readily understood by referring to the attached drawings in combination with the following description.

In an injection molding machine, a block 10 is utilized to distribute the molten plastic that is supplied to the mold. A barrel 17 is attached to one end of the block and a rod 15 is moveably positioned in the block to control the flow of the molten plastics. The block has a top 12, a bottom 14, opposed sides 16 and opposed ends 18. A bore 20 extends from the bottom 14 to the top 12 of the block. The source of molten plastic is supplied to the bore 13. The molten plastic is supplied under pressure sufficient to cause the molten plastic to exit the bore. The nozzle is utilized to distribute molten plastic to a mold that is operatively connected to the nozzle. A bushing 24 is removably positioned in the bore 20 adjacent the top 12. The rod 15 passes through the bushing and the bushing assists in locating the rod as the rod is moved in the bore. The bushing 24 is secured in the bore so that it remains in the desired position in the block while distributing the molten plastic to the mold. A notch 26 is positioned the outer circumference 22 of the bushing. The bushing 24 is subjected to significant force from the movement of the rod and from the molten plastic that is forced through the bore 13 during the operation of the injection molding machine. The bushing is a wear item that must be replaced periodically. Accordingly, it is important that the bushing be removably positioned and secured in the bore 20.

A channel 28 is formed in the top 12 of the block 10. The channel extends from the bore 20 in a direction towards one of the ends 18 or one of the sides 16 of the block. The channel has a first section 30 with a first width and a second section 32 with a second width. The second width is smaller than the first width. A shoulder 36 is formed on each side of the channel 28 where the second width connects with the first width.

A keeper 40 is utilized for releasably securing the bushing 24 in the bore 20. The keeper has a first portion 42 having a first width and a second portion 46 having a second width. The second width is smaller than the first width. A detent 48 is defined where the second portion connects with the first portion. The width of the first portion is substantially the same as the width of the first section and the width of the second portion is substantially the same as the width of the second section. The keeper 40 is designed to fit into the channel 28 with the first portion in alignment with the first section and the second portion in alignment with the second section. The detent 48 is designed to engage the shoulder 36 in the channel 28. A projection 52 extends from the first portion 42 of the keeper 40. The projection 52 is disposed to extend into the bore 20 and to engage the notch 26 on the bushing 24. At least one opening 54 extends through the keeper in a direction that is substantially parallel to the bore 20. The at least one opening is positioned to be in alignment with an at least one threaded aperture 11 that extends from the channel 28 into the block 10. At least one threaded aperture is disposed to be substantially perpendicular to the bore 20. An at least one bolt 56 can be positioned in the at least one opening 54 and engage the at least one threaded aperture 11 to secure the keeper 40 to the block 10.

In operation, the bushing 24 is positioned adjacent the keeper 40 with the projection 52 on the keeper in engagement with the notch 26 on the bushing. The bushing and keeper are then positioned with the bushing in the bore 20 and the keeper in the channel 28. The bushing and keeper are positioned as a single component and this avoids alignment issues between the bushing and the bore. The bolts 56 is then positioned in the opening 54 and threaded into the threaded aperture 11 in the block 10 to secure the keeper 40 and the bushing 24 in the block 10. When it is time to replace the bushing 24 the bolts 56 is removed from the threaded aperture 11 and the opening 54. Once the bolts have been removed the keeper 40 and the bushing 24 can be removed from the block 10. A new bushing can then be positioned on the keeper 40 and positioned in the block 10 in the manner previously described.

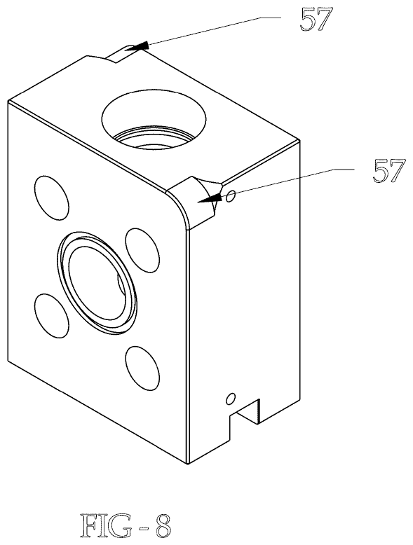

FIG. 8 shows an additional feature of the invention. A plurality of arcuate section's 57 have been added to the bottom of the block 10. The arcuate sections are positioned to allow wires and other control elements to be positioned in a desired location. The arcuate sections provide a smooth curved surface for the control elements. Although the arcuate section's 57 are shown as being in the bottom of the block 10, it should be understood that the arcuate sections can be located anywhere on the block where the control elements are located.

The above description is given for the sake of explanation. Various modifications, substitutions, and changes can be made without departing from the scope of the following claims.

1. An injection molding device comprising:
a substantially rectangular block having a top, a bottom, two side surfaces and two end surfaces, the block having a bore that extends from the bottom to the top,
a bushing removably positioned in the bore, the bushing disposed for controlling the movement of a rod located in the bore, a notch disposed on one side of the bore,
a channel positioned in the top, the channel extending from the bore, the channel having a first section with a first width and a second section with a second width smaller than the first width,
a keeper for releasably securing the bushing in the bore, the keeper having a first portion with a first width and a second portion with a second width smaller than the first width, a projection extending from the first portion of the keeper, the projection positioned to engage the notch in the bushing to retain the bushing in a desired position in the bore.

2. The device of claim 1 wherein the first portion of the keeper has a radiused end that is disposed to engage a side of the bushing, the projection extending from the radiused end.

3. The device of claim 1 wherein at least one shoulder is defined where the second section joins the first section.

4. The device of claim 3 wherein at least one detent is defined where the second section joins the first section.

5. The device of claim 4 wherein the at least one detent on the keeper is disposed to engage the at least one shoulder in the channel.

6. The device of claim 1 wherein the channel extends from the bore to one of the sides of the block.

7. The device of claim 1 wherein the channel extends from the bore to one of the ends of the block.

8. The device of claim 7 wherein at least one opening extends through the keeper and at least one threaded aperture is positioned in the block, the at least one opening being in alignment with the at least one threaded aperture.

9. The device of claim 8 wherein a bolt is positioned in the at least one opening and at least one threaded aperture to secure the keeper to the block.

10. A method for securing a bushing in an injection molding machine comprising:
forming a channel in a block used to delivering material to an injection mold, the channel being located adjacent a bore in the block,
forming a notch in a bushing that is positioned in the bore,
positioning a keeper adjacent to the bushing, the keeper having a projection that engages the notch in the bushing,
releasably positioning the keeper and bushing as a joined component on the block wherein the keeper is positioned in the channel and the bushing is positioned in the bore.

11. The method of claim 10 in which the channel forms at least one shoulder and the keeper has at least one detent engaging the at least one shoulder.

12. The method of claim 10 in which the keeper is secured to the block to maintain the bushing in the desired location.

13. The device of claim 1 wherein an arcuate section is positioned on the block to provide a desired location for control elements.
